(19) United States
(12) Patent Application Publication
(10) Pub. No.: US 2026/0042131 A1
(43) Pub. Date: Feb. 12, 2026

(54) Biomass Sinking System

(71) Applicant: C-SINK LTD., Tel Aviv (IL)

(72) Inventors: Kobi Kaminitz, Ramat Gan (IL); Ram Amar, Shorashim (IL)

(21) Appl. No.: 19/099,059

(22) PCT Filed: Jul. 19, 2023
(86) PCT No.: PCT/IB2023/057350

§ 371 Date: Jan. 28, 2025

Related U.S. Application Data
(60) Provisional application No. 63/392,874, filed on Jul. 28, 2022.

(51) Int. Cl. B09B 1/00; B09B 101/85; B63B 35/00

(52) U.S. Cl. CPC B09B 1/002; B63B 35/00; B09B 2101/85

(57) ABSTRACT

A method for sequestering carbon in a body of water (28), the method consisting of receiving a mass (52) of carbon-containing matter, the mass having an initial average density that is less dense than the water, and submerging the mass in the body of water to a depth (66) at which the mass becomes denser than the water due to compression of the mass by water pressure. When the mass has become denser than the water, the method includes releasing the mass to sink in the body of water. The mass of carbon-containing matter may be in the form of loose matter or bales.

### CROSS-REFERENCE TO RELATED APPLICATION

This application claims the benefit of U.S. Provisional Patent Application 63/392,874, filed July 28, 2022, which is incorporated herein by reference.

### FIELD OF THE INVENTION

The present invention relates generally to carbon sequestration, and specifically to sequestration of organic matter.

### BACKGROUND OF THE INVENTION

Climate change is an existential risk, and the time to mitigate devastating consequences is running out. One of the main causes of climate change is the increase in concentration of carbon dioxide (CO₂), a greenhouse gas, in the atmosphere, and to counter this it is necessary to remove gigatons (billions of tons) CO₂ from the atmosphere. It is unfeasible to directly capture and remove such large amounts. So it make sense to use plants that captured CO₂ during photosynthesis, and sequester them for thousands of years.

### SUMMARY OF THE INVENTION

An embodiment of the present invention provides a method for sequestering carbon in a body of water, the method consisting of:
receiving a mass of carbon-containing matter, the mass having an initial average density that is less dense than the water;
submerging the mass in the body of water to a depth at which the mass becomes denser than the water due to compression of the mass by water pressure; and
when the mass has become denser than the water, releasing the mass to sink in the body of water.

In a disclosed embodiment the carbon-containing matter is in the form of a plurality bales, and thee mass includes a given bale selected from the plurality. Submerging the mass may include attaching the given bale to a connector of a cable, and translating the cable so that the given bale submerges to the depth. The method may also include releasing the given bale from the connector when the given bale is at the depth.

In a further disclosed embodiment the method includes receiving at least one more bale from the plurality of bales, each of the at least one more bale having the initial average density that is less dense than water, and wherein submerging the mass includes attaching the given bale and the at least one more bale to respective connectors of a cable so that combined weight of the given bale and the at least one more bale causes the cable to translate so that the given bale submerges to the depth.

The method may also include releasing the given bale from the respective connector when the given bale is at the depth. The method may further include receiving a further bale, from the plurality of bales, having the initial average density that is less dense than water, and, after releasing the given bale from the respective connector thereof, attaching the further bale to the respective connector.

In an alternative embodiment the carbon-containing matter is in the form of loose matter, and the mass consists of a portion of matter selected from the loose matter.

Submerging the mass may include enclosing the portion in a cage having an open bottom, and translating the cage so that the portion submerges to the depth. Translating the cage may include registering that the cage has reached the depth using an indication provided by at least one of a camera attached to the cage and an accelerometer attached to the cage.

There is further provided, according to an embodiment of the present invention, a method for sequestering carbon in a body of water, the method including:
receiving at least one bale of carbon-containing matter, each of the at least one bales having an initial average density that is less dense than the water;
attaching the at least one bale to a cable;
attaching a weight to the cable, so that the cable, the attached weight, and the attached at least one bale exert a net downward force when submerged in the water; and,
releasing the cable, the attached weight, and the at least one bale to sink in the body of water.

The method may include, prior to attaching the weight, computing a value of the weight so that the cable, the attached weight, and the attached at least one bale exert the net downward force when submerged in the water.

There is further provided, according to an embodiment of the present invention, apparatus for sequestering carbon in a body of water, consisting of:
a mass of carbon-containing matter, the mass having an initial average density that is less dense than the water; and
a motor, configured to:
submerge the mass in the body of water to a depth at which the mass becomes denser than the water due to compression of the mass by water pressure; and
when the mass has become denser than the water, release the mass to sink in the body of water.

There is further provided, according to an embodiment of the present invention, apparatus for sequestering carbon in a body of water, consisting of:
at least one bale of carbon-containing matter, each of the at least one bales having an initial average density that is less dense than the water;
a cable configured to attach to at least one bale; and
a weight configured to attach to the cable so that the cable, the attached weight, and the attached at least one bale exert a net downward force when submerged in the water, so that the cable, the attached weight, and the at least one bale sink in the body of water.

The present disclosure will be more fully understood from the following detailed description of the embodiments thereof, taken together with the drawings, in which:

### BRIEF DESCRIPTION OF THE DRAWINGS

FIGS. 1A, 1B, and 1C are schematic illustrations of a carbon sequestration system, according to an embodiment of the present invention;

FIG. 2 is a flowchart describing steps taken in operating the system, according to an embodiment of the present invention;

FIGS. 3A, 3B, and 3C are schematic illustrations of an alternative carbon sequestration system, according to an embodiment of the present invention;

FIG. 4 is a flowchart describing steps taken in operating the alternative system, according to an embodiment of the present invention;

FIGS. 5A, 5B, 5C and 5D are schematic illustrations of a further alternative carbon sequestration system, according to an embodiment of the present invention; and

FIG. 6 is a flowchart describing steps taken in operating the further alternative system, according to an embodiment of the present invention.

### DETAILED DESCRIPTION OF EMBODIMENTS

### Overview

Embodiments of the present invention provide a method for sequestering large quantities of biomass, i.e., matter containing carbon, typically at a megaton scale. In some embodiments the matter, comprising organic waste such as dead vegetation and old or dead trees, is assembled into bales. The bales are placed on a ship, and the ship carries the bales to a location that is above a layer of water touching a sea-bed. In some embodiments the layer is euxinic and has minimal overturning. (Euxinic layers with low or zero overturning of water exist, for example, at the bottom of the Black Sea, and may also exist in some of the Great Lakes.) The bales are then sunk to a known region of the sea-bed at the bottom of the layer.

While the bales are typically initially less dense than water, the inventors have found that once a given bale is beneath a predetermined depth, herein termed the target depth, the bale compresses to become more dense than water. Embodiments of the invention use this property to provide a mechanism on the ship that facilitates sinking all the bales to the layer, at a sea-bed region beneath the ship.

The present disclosure provides two examples of the bale lowering mechanism. A third example, that can be used for baled or non-baled material, is described below. Both bale lowering examples use collections of bales sequentially coupled to a cable that is lowered from the ship, and the apparent weight of the lower compressed bale, or bales, is used to pull bales, further up the cable, down.

In a first disclosed embodiment the cable has sequential bale couplings that enable bales to be removably attached to the cable. The cable is in the form of a loop suspended from the ship, with a lower part of the loop at a predetermined position below the target depth. Bales are successively added to the couplings on one side of the loop, and the loop is initially rotated until the lowest bales move below the target depth. The predetermined position of the loop lower part is selected so that the lowest bales then pull the upper bales down so continuing to rotate the loop.

As it reaches the lowest part of the loop the lowest bale may then be released from its coupling, so that it sinks of its own volition to a sea-bed region below the loop. As the loop rotates more bales may be added to the couplings, and the process repeated, until all bales on the ship have sunk to the sea-bed region.

In a second disclosed embodiment the cable is not looped; rather the cable is initially generally linear and one end of the cable has a weight attached. (There is an optimal value for the weight, explained below.) The other end of the cable is left untethered on the ship. The bales are sequentially fixedly attached to the cable, and the weighted end of the cable is then lowered from the ship to a predetermined position (which may or may not be different from the predetermined position the first disclosed embodiment) to below the target depth. This leaves bales remaining on the ship, with the rest of the bales in the water.

The weight and the predetermined position are selected so that, considering all the bales in the water, i.e., those above the target depth and those below the target depth, there is a resultant downward force on the immersed material—the weight, the cable and the bales. The optimal value of the weight is the minimum weight for the downward force to exist.

The resultant downward force is used to pull the cable section that is on the ship, with its remaining attached bales, into the water. As the cable is pulled, more bales may be added to the cable. Since the cable end on the ship is untethered, the complete system, i.e., the weight, the cable, and the attached bales, enters the water, and sinks to the sea-bed region.

In a further embodiment the matter to be sequestered does not need to be assembled into bales, but rather may be provided as unpackaged bulk cargo, also herein termed loose matter, which is placed on a ship. As for the embodiments described above, the ship carries the loose matter or the bales to a location that is above a selected layer of water.

The ship is provided with a crane, having an enclosure, also herein termed a cage, attached to a cable. The cage has an open bottom, and the crane operates the cable to lower the cage into the water, typically so the cage bottom is just below the surface of the water. If loose matter is used, it is placed into the cage, typically in portions, also herein termed batches or masses, using another crane on the ship, and because the loose matter is less dense than the water, the loose matter floats but is restrained by the cage. Bales may also be used instead of the masses of loose matter, and in the description herein, the term mass is assumed to comprise a portion, of loose matter to be sequestered, or a bale, of loose matter to be sequestered.

Enough mass may be placed in the cage so long as the weight of the cage is greater than the buoyant force from the mass, so there continues to be a net downward force on the combined mass and cage. The crane may then lower the cable with its contained mass further into the water. Once the cage with its mass reaches the target depth, the mass compresses to become denser than water, so it begins to sink of its own volition, through the open bottom of the cage, to the sea-bed region. The crane may then raise the cage to the water surface for further sinking portions or bales of the loose matter.

### DETAILED DESCRIPTION

In the following description, like elements in the drawings are identified by like numerals, and like elements are differentiated as necessary by appending a letter to the identifying numeral.

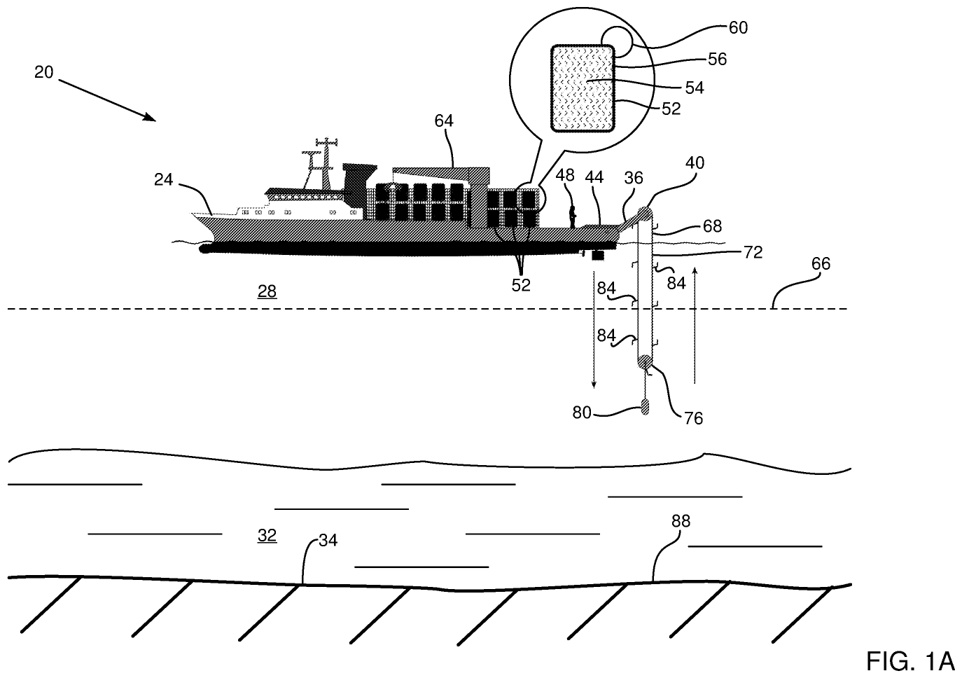

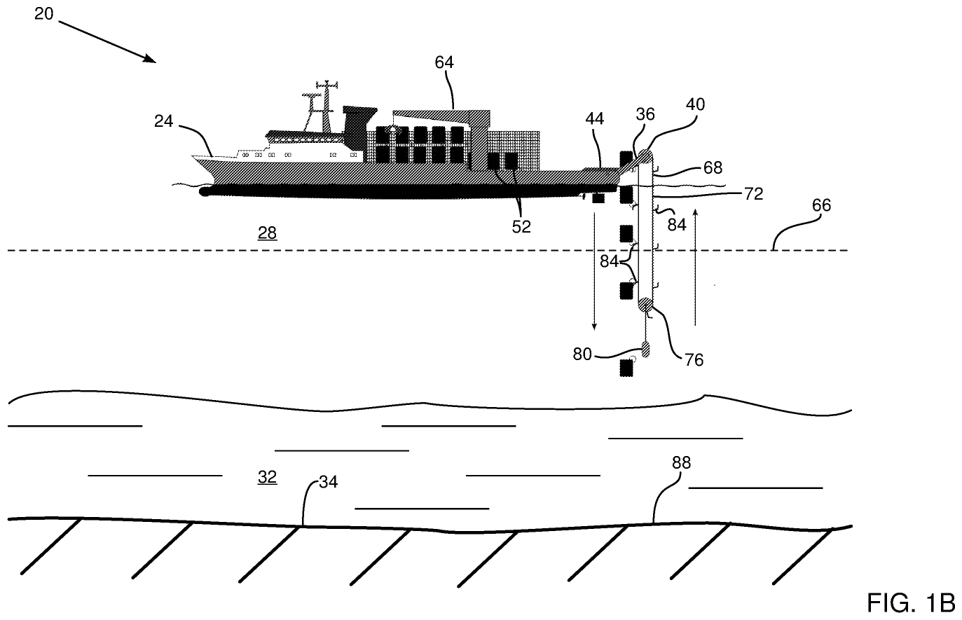

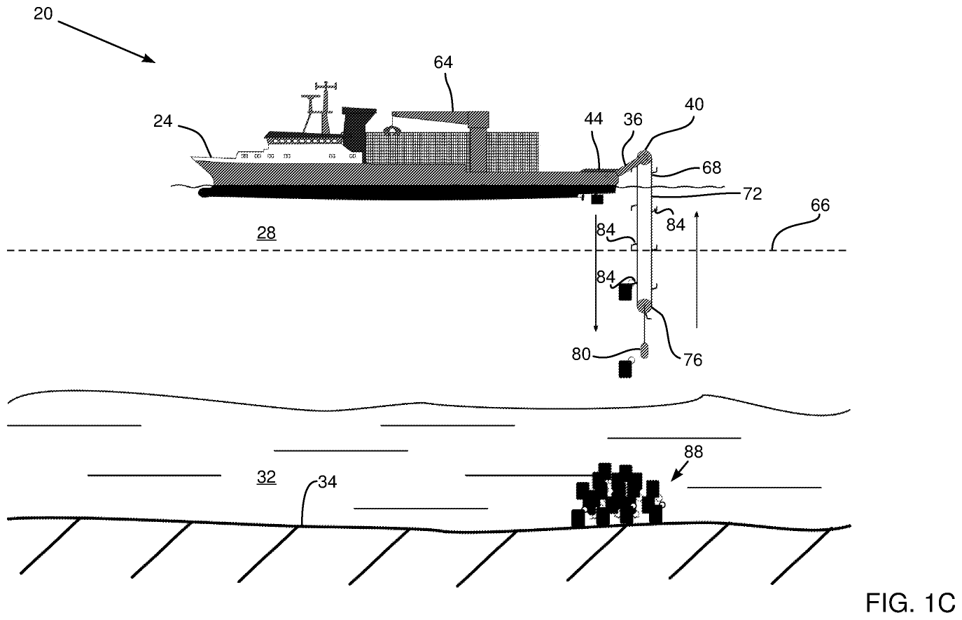

FIGS. 1A, 1B, and 1C are schematic illustrations of a carbon sequestration system 20, according to an embodiment of the present invention. FIG. 1A illustrates the system in an initial stage of operation, FIG. 1B illustrates the system in an intermediate stage, and FIG. 1C illustrates the system in a final stage of operation.

System 20 is assumed to have been installed on a cargo ship 24, and the ship is assumed to be floating on a body of water 28 which in one embodiment has a euxinic layer 32, the layer also having low or even zero overturning. Euxinia or euxinic conditions occur when water is both anoxic and sulfidic. This means that there is no oxygen (O₂) and a raised level of free hydrogen sulfide (H₂S). One example of such a body of water is the Black Sea, although other bodies of water with euxinic low overturn layers exist, e.g., Framvaren Fjord in Norway, and the Cariaco Basin in Venezuela. Layer 32 is typically a lowest layer in body of water 28, and so is herein assumed to be a layer contacting the sea-bed 34 of the body of water.

In an alternate embodiment, layer 32 is not euxinic.

Located on a part of the ship, herein by way of example assumed to be the stern of the ship, is a pulley support 36 that retains a pulley 40. A motor 44, coupled to the pulley, is configured to rotate the pulley when powered on by an operator 48 of the system. Bales 52 of organic carbon-containing matter that are to be sequestered by the system are stacked on the ship's deck or in a hold thereof. Bales 52 are also herein referred to as masses 52. Bales 52 are typically comprised of organic vegetable matter 54, such as dead wood or material that has been pruned and bundled in a wrapping 56. In the figure, a call-out schematically illustrates a bale 52, comprising organic vegetable matter 54 bundled in wrapping 56. Wrapping 56 is herein assumed to be any convenient material that retains the matter of its bale as a single bundle. Examples of wrapping 56 comprise a net that encloses matter 54, and string that wraps around the matter of the bale.

In one embodiment, bales 52 have a volume of approximately 1 m³ and a mass of approximately 800 kg but other embodiments may have bale volumes and masses that are larger or smaller than 1 m³ and 800 kg.

Each bale 52 has a respective coupling 60, as shown in the call-out, that may be used to lift the bale. In some embodiments, wrapping 56 acts as coupling 60, so that there is no need for a separate coupling. System 20 also comprises a crane 64, typically installed on ship 24, that system operator 48 is able to control, and that is configured to lift and translate the bales using coupling 60.

Each bale 52, with its wrapping 56, has an initial average density that is less dense than water and, consequently, on its own floats on water. However, the inventors have found that if a bale with its wrapping is lowered into water to or below a predetermined depth 66, herein also termed the target depth 66, the pressure of the water compresses the bale so that it becomes more dense than water, and thereby sinks. In one embodiment of the invention the target depth is approximately 30 m, but the inventors believe that the target depth is in a range from approximately 10 m to approximately 50 m or even more.

The target depth is a function of how the material of a given bale 52, with its wrapping 56, is assembled, and it is also a function of the temperature and the salinity of the water. It will be understood that one of ordinary skill in the art will be able to determine the target depth, for any given set of bales 52 and a given body of water, without undue experimentation.

A cable 68, in the form of a loop 72 is suspended from pulley 40, and the loop is maintained in a substantially vertical orientation by passing around a lower pulley 76 that has a weight 80 attached. Cable 68 has a series of connectors 84, typically equally spaced, coupled to the cable, and the connectors are configured to removably attach to coupling 60. As is illustrated in FIGS. 1A, 1B, and 1C, lower pulley 76 is below target depth 66, and embodiments of the invention configure loop 72 so that the lower pulley is at, or below, preset lower pulley position, explained hereinbelow, below the target depth.

FIG. 1B illustrates schematically that during the intermediate stage of operation of system 20 bales 52 are attached by connectors 84 to cable 68, and there are attached bales in the water that are above and below the target depth. By virtue of their density, bales 52 in the water above the target depth exert an upward force on the cable, while bales 52 below the target depth exert a downward force on the cable. Typically, at least one attached bale 52 above the water exerts a downward force on the cable.

Embodiments of the invention position lower pulley 76 so that when all connectors 84 on one side of loop have bales attached, there is a resultant downward force on the cable of the loop. The position corresponds to the preset lower pulley position referred to above, and it is a function, inter alia, of the weights of bales 52 and their wrappings 56, how the material of the bales and wrappings is assembled, the target depth, and the distribution of connectors 84 on the cable of the loop. As for the target depth, one of ordinary skill in the art can find the preset lower pulley position for system 20 for any given set of bales 52 in a selected body of water.

As is illustrated in FIG. 1C, in the final stage of operation, bales 52 have all sunk to a region 88 on sea-bed 34.

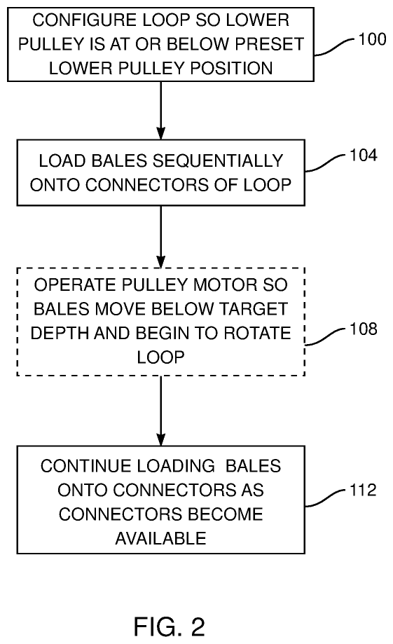

FIG. 2 is a flowchart describing steps taken in operating system 20, according to an embodiment of the present invention.

In an initial preparation step 100 operator 48 calculates the target depth of the body of water where system 20 is to be operated. Once the target depth has been calculated, the operator determines the preset lower pulley position. The determination of the target depth and the preset lower pulley position are as described above. The operator then configures loop 72, typically by setting a length of cable 68 making the loop, and also by adjusting support 36 of the crane, so that lower pulley 76 is at or below the preset lower pulley position, as illustrated in FIG. 1A.

In an initial operation, step 104 operator 48 controls crane 64 to sequentially load bales 52 onto connectors 84. The loading is accomplished by the crane attaching coupling 60, or wrapping 56 if the wrapping is used as the coupling, of a given bale to a connector 84 that does not have a bale already attached. As stated above, the bales and their wrapping are initially less dense than water. Thus, although the first bale loaded onto loop 72 may pull the cable of the left-side of the loop to translate down until the bale enters the water, as more bales are loaded onto connectors, bales entering the water may slow or even stop the loop from moving.

In a motor operation step 108, indicated in the flow chart as optional by enclosing the details of the step in a dashed rectangle, operator 48 powers motor 44 on to maintain the movement of the loop, i.e., with the left side of the loop translating down, and thus the right-side translating up, as shown by the vertical arrows in FIGS. 1A, 1B, 1C.

The operator continues to power the motor on while crane 64 continues to load bales 52 onto connectors 84, until the loop continues to move of its own volition. Once the loop has begun to move of its own accord, the operator may cease powering the motor on. In some embodiments, the motor may be powered off automatically, in response to the loop moving of its own accord.

As is illustrated in FIG. 1B, as a bale reaches lower pulley 76, its connector 84 is configured to release the bale so that the bale is free to sink.

In a final step 112, operator 48 continues to load bales 52 onto connectors 84. While the connectors on the left side of the loop are fully populated, the loop continues to rotate, and bales continue to be released and sink as they reach lower pulley 76. Final step 112 continues until all bales 52 have been loaded on to connectors 84, and been released from their connectors, to sink to region 88.

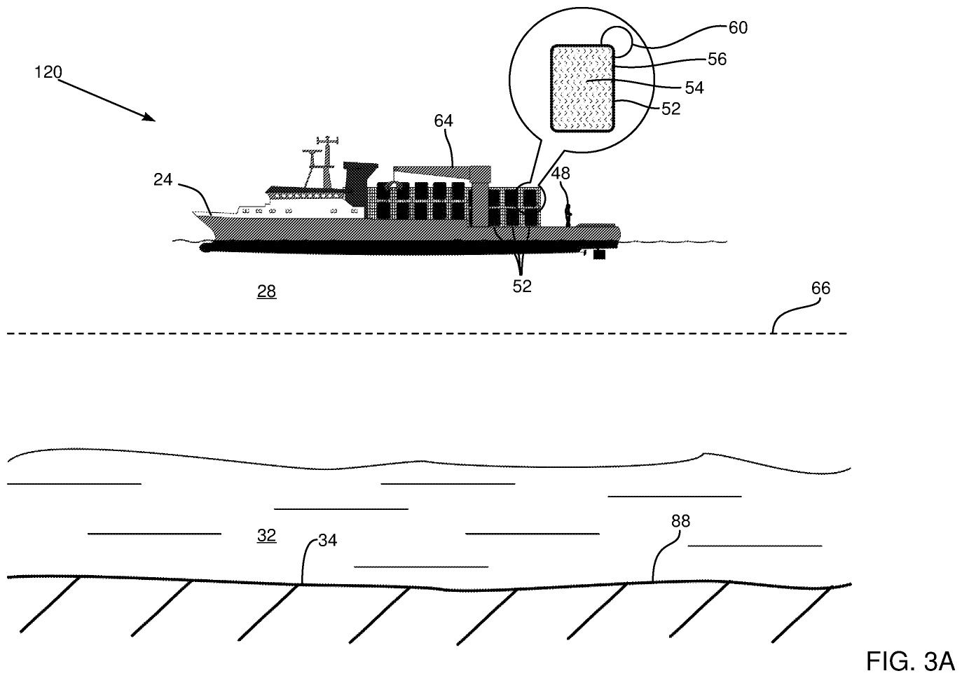

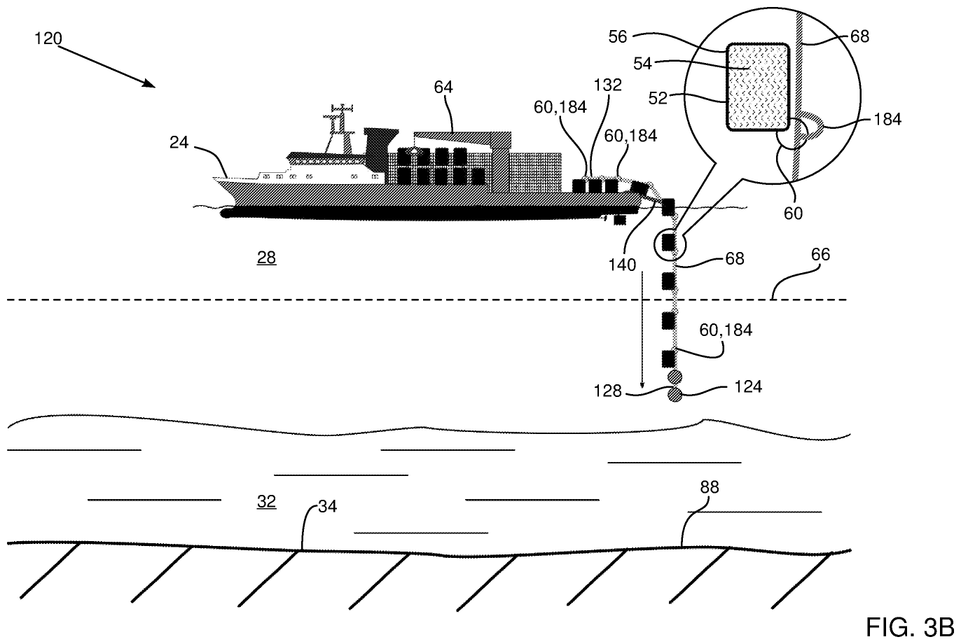

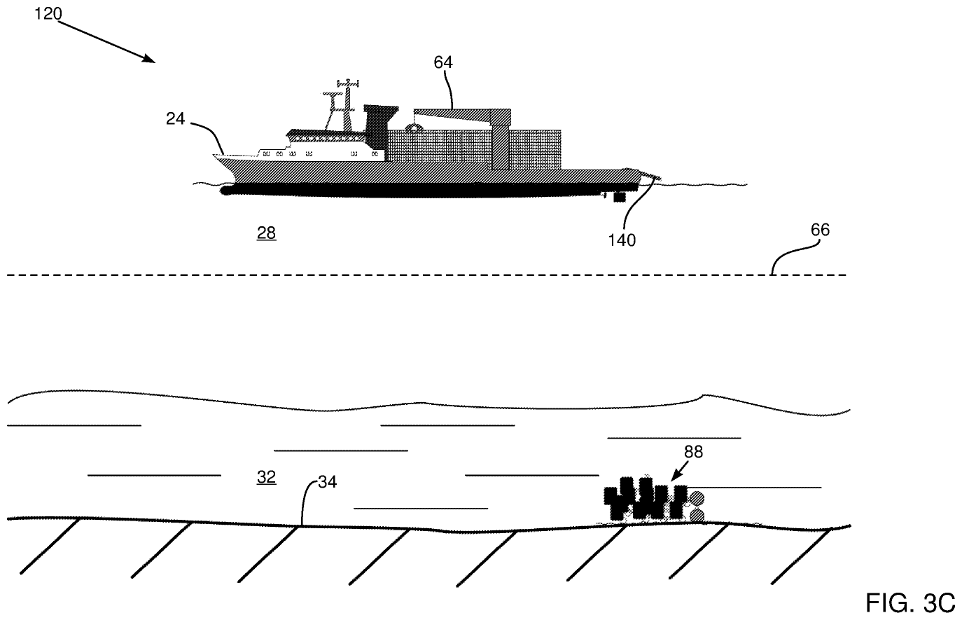

FIGS. 3A, 3B, and 3C are schematic illustrations of a carbon sequestration system 120, according to an alternative embodiment of the present invention. FIG. 3A illustrates the system in an initial stage of operation, FIG. 3B illustrates the system in an intermediate stage, and FIG. 3C illustrates the system in a final stage of operation.

Apart from the differences described below, the operation of system 120 is generally similar to that of system 20 (FIGS. 1A, 1B, 1C, and 2), and elements indicated by the same reference numerals in both systems 20 and 120 are generally similar in construction and in operation.

System 120 uses cable 68. However, in contrast to system 20, the cable is not in the form of a loop. Furthermore, system 120 does not use pulley support 36 or associated pulleys, and there is no motor 44 for driving pulleys. Also in contrast to system 20, in system 120, connectors 184 to bale couplings 60 of respective bales 52 are not designed to release the bales. In system 120, cable connectors 184, described below, are designed to fix the bales to cable 68.

Cable 68 has a weight 124 tethered to one end 128 of the cable, and the other end 132 may be untethered or tethered to ship 24. A method for calculating the value of weight 124, herein also termed operating weight 124, is described below. As for system 20, in system 120 cable 68 has a series of connectors 184, typically equally spaced, coupled to the cable, but in system 120, once connected, each connector is configured to remain fixed to a respective coupling 60. A connector 184 is shown in more detail in a call-out to FIG. 3B.

Initially, bales are fixedly connected by couplings 60 to connectors 184, and operating weight 124 is pushed, via a ramp 140, typically projecting from the stern of the ship, into water 28. This causes the operating weight and its attached cable to sink, pulling bales 52 that are also attached into the water.

While attached bales 52 are above target depth 66 they exert an upward force on the combined system of cable, bales and operating weight. The upward force may be strong enough to counteract the force down from weight 124, so that the weight does not continue to sink. Consequently, a minimum value of weight 124 is such that for the situation of a fully populated cable with all bales above target depth 66, there is a net downward force on cable 68. It will be understood that the minimum value for operating weight 124 may be determined without undue experimentation.

Provided operating weight 124 is at least the minimum value referred to above, the weight and its attached cable 68 will continue to sink, regardless of whether or not there are bales attached to the cable. Assuming that bales are attached to the cable, either before weight 124 enters the water, or as the weight is sinking, the intermediate stage illustrated in FIG. 3B occurs. The attachment is typically performed by operator 48 controlling crane 64. The final stage, when weight 124, all bales attached to the cable, and the cable, have left the ship, is illustrated in FIG. 3C, showing that all bales have sunk to region 88.

Depending, inter alia, on the number of bales 52, and the available length of cable 68, the process of sinking bales, using system 120, may be performed in batches. I.e., a given cable 68, with its attached operating weight 124, may be used to sink a group of bales 52, and the process repeated for further cables 68 with respective attached operating weights 124, each cable sinking a respective group of bales 52.

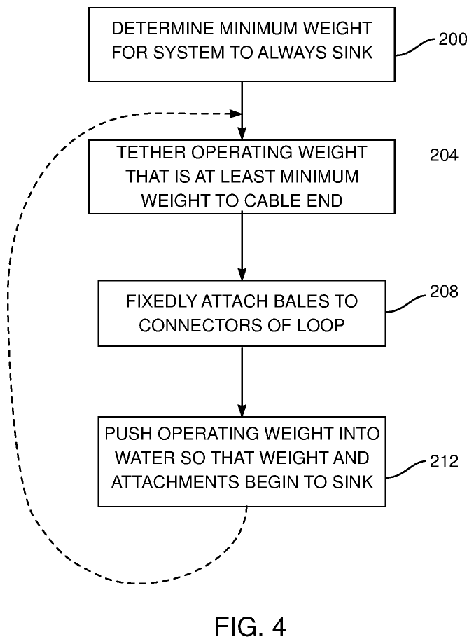

FIG. 4 is a flowchart describing steps taken in operating system 120, according to an embodiment of the present invention.

In a preparation step 200 the minimum value of operating weight 124, for the system to be operated in body of water 28, is determined, substantially as described above.

In an initial operating step 204, operating weight 124 is tethered to an end of cable 68.

In a loading step 208, bales 52 are fixedly attached using connectors 184 and couplings 60, to cable 68.

In a final step 212, the tethered operating weight 124 is pushed into body of water 28. Once in the water, weight 124 translates its attached cable, and bales attached to the cable, down, so that all begin to sink.

As explained above, depending on the number of bales to be sunk, steps 204, 208, and 212 of the flowchart may reiterate, as shown by the dashed arrow in the flowchart, so that the sinking of bales 52 is performed in batches.

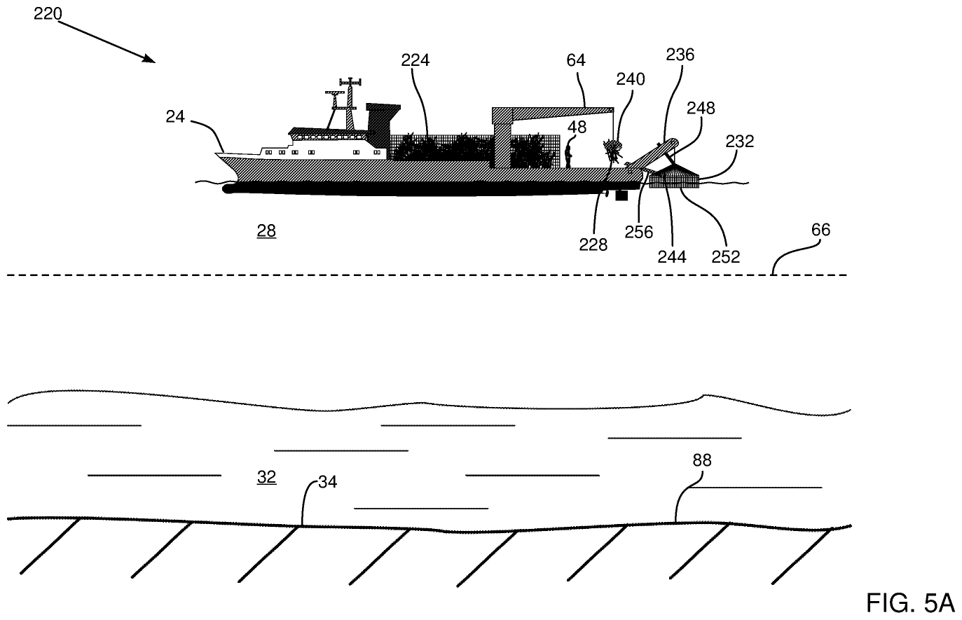

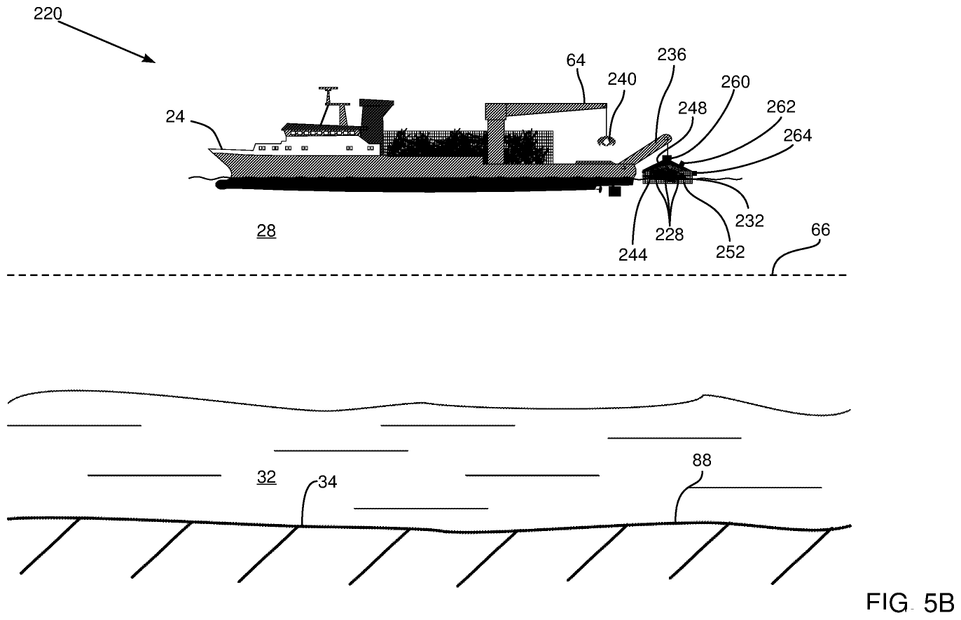

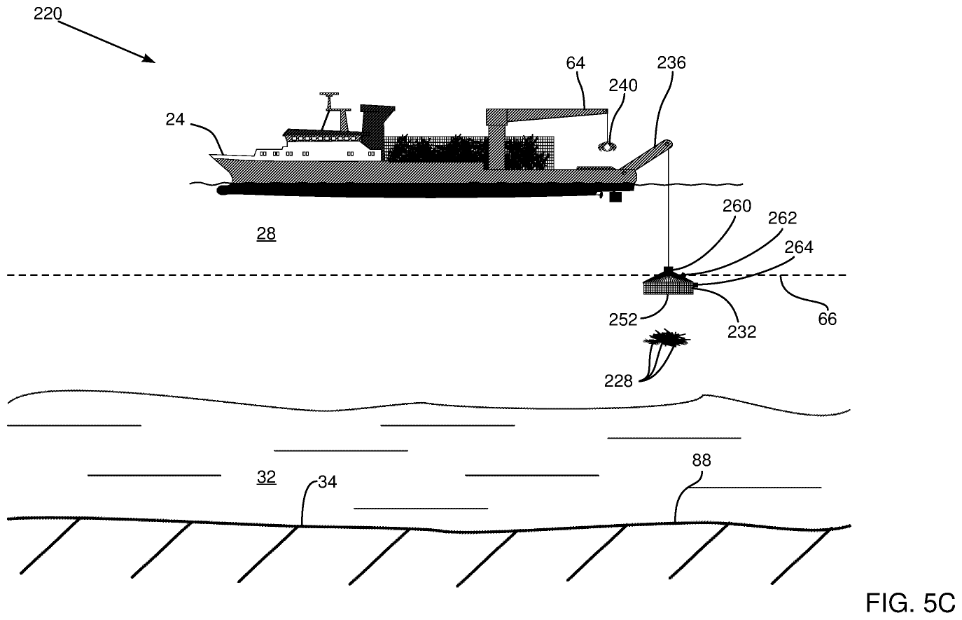

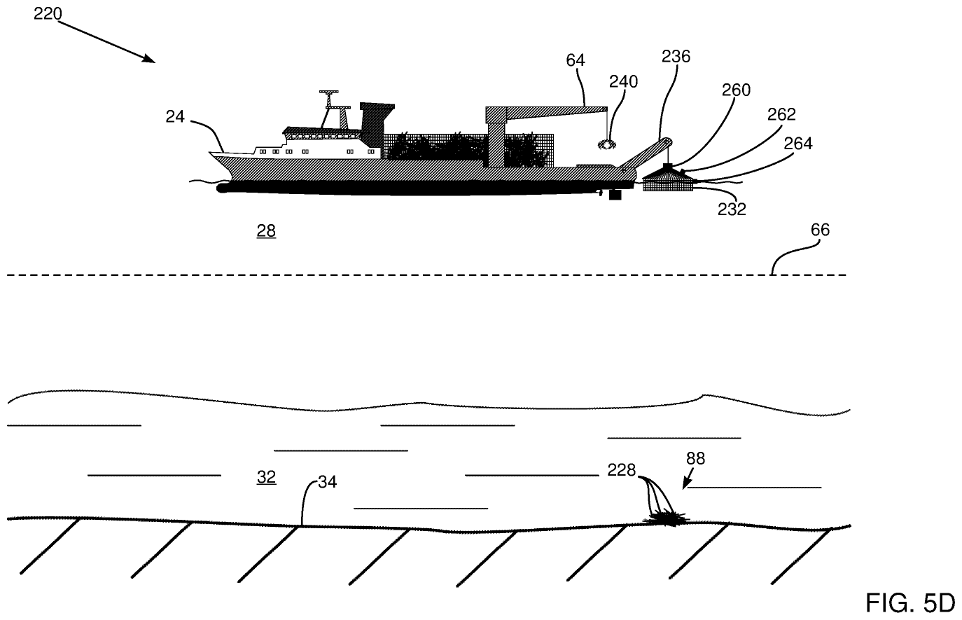

FIGS. 5A, 5B, 5C and 5D are schematic illustrations of a carbon sequestration system 220, according to a further alternative embodiment of the present invention. FIG. 5A illustrates the system in an initial stage of operation, FIGS. 5B and 5C illustrate the system in intermediate stages, and FIG. 5D illustrates the system in a final stage of operation.

Apart from the differences described below, the operation of system 220 is generally similar to that of systems 20 and 120 (FIGS. 1A-4), and elements indicated by the same reference numerals in systems 20, 120, and 220 are generally similar in construction and in operation.

In contrast to systems 20 and 120, system 220 may operate with bales or with unpackaged bulk cargo of carbon-containing matter, SO that in one embodiment ship 24 may be a bulk carrier. The following description assumes that the material to be sequestrated by system 220 comprises unpackaged bulk cargo of carbon-containing matter 224, herein also termed loose matter 224, and those having ordinary skill in the art will be able to adapt the description, mutatis mutandis, if the material to be sequestrated is in bales.

As illustrated in FIG. 5A, loose matter 224 is initially stored on the deck of ship 24. In an alternative embodiment loose matter 224 may be stored in one or more holds of ship 24.

As for bales 52, in its initial state the average density of loose matter 224 is less than that of water. As is also the case for loose matter 224, if the loose matter, or a portion thereof, is submerged to target depth 66, the water pressure compresses the submerged material so that it has a density greater than that of water, and so sinks unless restrained.

Once ship 24 is in position, i.e., is floating on body of water 28 having a layer 32, crane 64 is operated to transfer one or more batches 228 of loose matter 224 to float the surface of water 28, while being confined within a cage 232. Cage 232 is attached to a cage-crane 236, which is configured to be able to lower and raise the cage. Batches 228 are also referred to herein as masses 228. Typically multiple masses 228 are transferred into cage 232 while the cage is at the surface of water 28, and FIG. 5A illustrates a first mass 228, that a grab 240 attached to the crane is transferring to cage 232.

In order for cage 232 to receive batches 228, the cage has an opening 244 in an upper section of the cage, and the opening may be closed with a flap 248. Cage 232 does not completely surround batches 228 placed within the cage, even with flap 248 closed, since the cage is constructed to have an open bottom 252. In the embodiment illustrated in FIG. 5A, a removable ramp 256, between the deck of ship 24 and opening 244, is used to slide masses 228, so as to facilitate the transference of the masses through the opening into cage 232.

While the description above assumes that crane 64 and ramp 256 are used to transfer multiple masses 228 into cage 232, those having ordinary skill in the art will be aware of other methods for effecting such transfer, for example transferring the masses without using a ramp, and all such methods are assumed to be comprised within the scope of the present invention.

As for systems 20 and 120, operator 48 operates the elements of system 220, including, but not limited to, crane 64, cage 232, flap 248, and cage-crane 236.

In some embodiments, operator 48 may register the net downward force of cage 232, closed by flap 248, with the cage in water 28 but having no batches 228 of matter 224 within the cage. The registered net downward force, herein termed the empty cage downward force, may be used as an indication of the presence of masses 228 in the cage, as is described below.

FIG. 5B illustrates a stage of system 220 wherein multiple batches 228 have been transferred to float on water 28, while being restrained by cage 232. In this stage ramp 256 has been removed from the cage, and flap 248 has closed opening 244. So that a subsequent lowering of cage 232, using cage-crane 236, is effective, the cage is configured to have sufficient weight so that when the cage-crane operates to lower the cage, the combination of the cage and the multiple batches restrained by the cage, when the batches completely submerge, generates a net downward force on the cage-crane.

In an embodiment, the mass of the cage is in a range of approximately 25% to approximately 50% of the mass of batches 228 restrained by the cage, so if the mass of the batches is approximately 800 kg, (which may be checked by measuring the weight of the mass in air, and which corresponds to the approximate mass of the bales described in system 20), the mass of the cage is between approximately 200 kg and approximately 400 kg. In other embodiments, the mass of the cage is outside the range of approximately 25% to approximately 50% of the mass of the batches.

The cage should be heavy enough to ensure that, with a maximum number of batches 228 inserted into the cage, the cage still lowers, i.e., has a net downward force. In some embodiments, operator 48 may check for the presence of the net downward force by lowering the cage further into the water, and observing that the cage continues to move downwards. If the cage does not move downward, some of the material of batches 228 may be removed from the cage, or alternatively one or more weights 260 may be added to the cage to achieve the required net downward force.

In some embodiments, a camera 262 is attached to the cage, the camera providing a view of material in the cage. An accelerometer 264 may also be attached to the cage. The functions of camera 262 and accelerometer 264 are described below.

FIG. 5C illustrates a stage of system 220 wherein cage-crane 236 has been operated to allow the net downward force of the combination of cage 232 and batches 228 to translate the combination downwards until the cage reaches target depth 66. At this depth, multiple batches 228 become denser than water, and so, since open bottom 252 of cage 232 does not restrain the multiple batches, the batches begin to sink, as shown in the figure. Also, at this depth, cage-crane 236 may stop the downward motion of cage 232.

In some embodiments, operator 48 may check that cage 232 has reached target depth 66 by noting that the net downward force is approximately equal to the empty cage downward force, described above with reference to FIG. 5A.

Alternatively or additionally, operator 48 may perform the check by registering that camera 262 no longer shows images of batches 228, and/or by noting a change in the cage acceleration as indicated by accelerometer 264.

FIG. 5D illustrates a stage of system 220 wherein batches 228 have sunk to region 88 on sea-bed 34. Cage-crane 236 has been operated to return cage 232 to the surface of water 28, wherein it may be loaded with further masses of loose matter 224, as described above with reference to FIG. 5A.

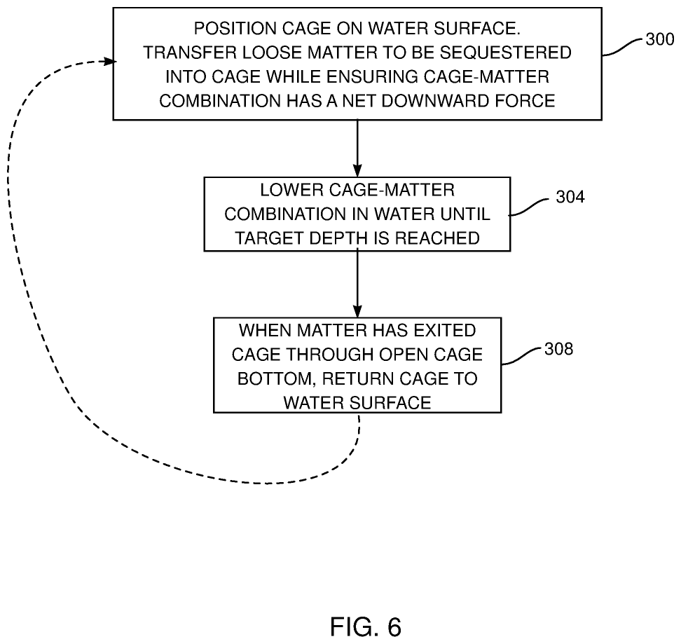

FIG. 6 is a flowchart describing steps taken in operating system 220, according to an embodiment of the present invention.

In an initial step 300, operator 48 uses cage-crane 236 to position cage 232 on the surface of body of water 28. The operator then transfers one or more masses 228 of loose matter 224 into the cage, via upper opening 244. The transfer may continue so long as the combination of the transferred mass and cage 232 exert a net downward force. Operator 48 may ensure the presence of a net downward force, as described above with reference to FIG. 5B, and the operator may then close upper opening 244 of cage 232, using flap 248.

In a lowering step 304, cage-crane 236 is activated to lower the closed cage 232, with its enclosed masses 228 of loose matter, into body of water 28. The lowering is continued until the cage-matter combination reaches target depth 66, at which point because it is now denser than water, masses 228 exit cage 232 through open bottom 252 and sink of their own accord. In some embodiments, the operator may determine that target depth 66 has been reached by registering that the net downward force on cage-crane 236 is approximately equal to the empty cage downward force, and/or by noting a change in the image presented by camera 262, and/or by noting a change in the acceleration registered by accelerometer 264.

In a final step 308, when masses 228 have exited cage 232, cage-crane 236 is operated to return the cage to the surface, so that the cage is able to receive more batches 228.

As indicated in the flowchart by the broken arrow between steps 308 and 300, steps 300, 304, and 308 may be reiterated until all loose matter 224 has sunk.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for sequestering carbon in a body of water, the method comprising:
receiving a mass of carbon-containing matter, the mass having an initial average density that is less dense than the water;
submerging the mass in the body of water to a depth at which the mass becomes denser than the water due to compression of the mass by water pressure; and
when the mass has become denser than the water, releasing the mass to sink in the body of water.

2. The method according to claim 1, wherein the carbon-containing matter is in the form of a plurality of bales, and wherein the mass comprises a given bale selected from the plurality.

3. The method, according to claim 2, wherein submerging the mass comprises attaching the given bale to a connector of a cable, and translating the cable so that the given bale submerges to the depth.

4. The method according to claim 3, and comprising releasing the given bale from the connector when the given bale is at the depth.

5. The method according to claim 2, and comprising receiving at least one more bale from the plurality of bales, each of the at least one more bale having the initial average density that is less dense than water, and wherein submerging the mass comprises attaching the given bale and the at least one more bale to respective connectors of a cable so that combined weight of the given bale and the at least one more bale causes the cable to translate so that the given bale submerges to the depth.

6. The method according to claim 5, and comprising releasing the given bale from the respective connector when the given bale is at the depth.

7. The method according to claim 6, and comprising receiving a further bale, from the plurality of bales, having the initial average density that is less dense than water, and, after releasing the given bale from the respective connector thereof, attaching the further bale to the respective connector.

8. The method according to claim 1, wherein the carbon-containing matter is in the form of loose matter, and wherein the mass comprises a portion of matter selected from the loose matter.

9. The method according to claim 8, wherein submerging the mass comprises enclosing the portion in a cage having an open bottom, and translating the cage so that the portion submerges to the depth.

10. The method according to claim 9, wherein translating the cage comprises registering that the cage has reached the depth using an indication provided by at least one of a camera attached to the cage and an accelerometer attached to the cage.

11. A method for sequestering carbon in a body of water, the method comprising:
receiving at least one bale of carbon-containing matter, each of the at least one bales having an initial average density that is less dense than the water;
attaching the at least one bale to a cable;
attaching a weight to the cable, so that the cable, the attached weight, and the attached at least one bale exert a net downward force when submerged in the water; and,
releasing the cable, the attached weight, and the at least one bale to sink in the body of water.

12. The method according to claim 11, and comprising, prior to attaching the weight, computing a value of the weight so that the cable, the attached weight, and the attached at least one bale exert the net downward force when submerged in the water.

13. Apparatus for sequestering carbon in a body of water, comprising:
a mass of carbon-containing matter, the mass having an initial average density that is less dense than the water; and
a motor, configured to:
submerge the mass in the body of water to a depth at which the mass becomes denser than the water due to compression of the mass by water pressure; and
when the mass has become denser than the water, release the mass to sink in the body of water.

14. The apparatus according to claim 13, wherein the carbon-containing matter is in the form of a plurality of bales, and wherein the mass comprises a given bale selected from the plurality.

15. The apparatus according to claim 14, and comprising a cable having a connector attaching to the given bale, and wherein submerging the mass comprises the motor translating the cable so that the given bale submerges to the depth.

16. The apparatus according to claim 15, and comprising configuring the connector to release the bale when the bale is at the depth.

17. The apparatus according to claim 14, and comprising at least one more bale of carbon-containing matter, each of the at least one more bale having the initial average density that is less dense than water, and wherein submerging the mass comprises attaching the bale and the at least one more bale to respective connectors of a cable, so that a combined weight of the bale and the at least one more bale causes the cable to translate so that the bale submerges to the depth.

18. The apparatus according to claim 17, and comprising configuring the respective connector to release the bale when the bale is at the depth.

19. The apparatus according to claim 18, and comprising a further bale of carbon-containing matter having the initial average density that is less dense than water, and, configuring the respective connector to attach to the further bale after release of the bale.

20. The apparatus according to claim 13, wherein the carbon-containing matter is in the form of loose matter, and wherein the mass comprises a portion of matter selected from the loose matter.

21. The apparatus according to claim 20, wherein submerging the mass comprises enclosing the portion in a cage having an open bottom, and translating the cage so that the portion submerges to the depth.

22. The apparatus according to claim 21, wherein translating the cage comprises registering that the cage has reached the depth using an indication provided by at least one of a camera attached to the cage and an accelerometer attached to the cage.

23. Apparatus for sequestering carbon in a body of water, comprising:
at least one bale of carbon-containing matter, each of the at least one bales having an initial average density that is less dense than the water;
a cable configured to attach to at least one bale; and
a weight configured to attach to the cable so that the cable, the attached weight, and the attached at least one bale exert a net downward force when submerged in the water, so that the cable, the attached weight, and the at least one bale sink in the body of water.

24. The apparatus according to claim 23, wherein the weight has a predetermined value so that the cable, the attached weight, and the attached at least one bale exert the net downward force when submerged in the water.
